(19) United States
(12) Patent Application Publication
(10) Pub. No.: US 2007/0093250 A1
(43) Pub. Date: Apr. 26, 2007

(54) Method and system for routing toll-free calls to wireless devices

(75) Inventors: William E. Italia, Howell, MI (US); Robert J. Myers, Van Buren TWP, MI (US); Jeffrey P. Rysenga, Berkley, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: General Motors Corporation

(21) Appl. No.: 11/257,615

(22) Filed: Oct. 25, 2005

(51) Int. Cl. H04Q 7/20

(52) U.S. Cl. 455/445

(57) ABSTRACT

A method, computer readable medium and system for routing toll-free calls to wireless devices. One aspect of the invention provides a method, computer readable medium and system for receiving a non-translated telephone call at a wireless carrier including determining a serial number associated with the call based solely on a phone number associated with the call and routing the call from the wireless carrier to a mobile device based on the determination. Another aspect of the invention provides a method and computer readable medium for providing a communication number to the mobile device including receiving a non-geographic phone number, providing an equipment serial number unique to a mobile device, linking the phone number to the equipment serial number in a database, storing the phone number and equipment serial number to the mobile device and assigning the mobile device to a subscriber.

### FIELD OF THE INVENTION

This invention relates generally to data transmissions over a wireless communication system. More specifically, the invention relates to providing and routing non-geographic telephone numbers to wireless devices.

### BACKGROUND OF THE INVENTION

Many mobile vehicles incorporate an integrated communication system, such as a telematics unit, providing navigational assistance and other fee-based subscription services along with wireless communications. The telematics unit is assigned a wireless telephone number for communication in the same manner as a cellular telephone. One method 101 for manufacturing and activating telematics units is shown in FIG. 1A. An equipment serial number is assigned to the telematics unit during manufacturing of the telematics unit at step 103. A temporary wireless telephone number may be assigned at step 105. In step 107, the manufacturer of the mobile vehicle typically installs the telematics unit during manufacturing without a permanent wireless telephone number assigned and can only link the equipment serial number of the telematics unit to the vehicle identification number (VIN) at that time. Once the new vehicle reaches its destination and is sold or leased, at step 109 a wireless telephone number is assigned at step 193 based on the geographic area code where the vehicle is located. The mobile applications systems provider must then attempt to configure the telematics unit in step 195 while the vehicle is either at the dealership or in the end user's possession. Several configuration attempts may be required until activation is successful in step 197 and the process ends in step 199.

This process is expensive for the manufacturer. The programming and re-programming of local area code telephone numbers at the dealership level is labor intensive. In addition, the manufacturer must reserve blocks of telephone numbers in each area code to accommodate projected usage which creates an added cost for unused telephone numbers.

Receiving calls at the vehicle can be inconvenient and expensive for the calling party. For example, a telephone call to a vacationing owner would be routed through a long distance carrier to their home area code even though the vehicle may be only blocks away. In addition, if the owner of the vehicle is relocated or sold to a different area code, the vehicle must be brought to a dealership where a new wireless telephone number is assigned.

One possible alternative to the above process is the use of toll-free numbers assigned to the vehicle owner. However, toll-free number usage creates additional problems. Traditionally, toll-free services must be routed to a second geographic area code number or a customer's trunk line. In the case of telematics units, a geographic area code would have to be assigned to the telematics unit for the toll-free telephone number to be routed to. When toll-free numbers are dialed, the number is first looked up in a database to translate the toll-free number into a telephone number than can be routed to a destination. The call is then routed based on this “translated” number to its destination. A mobile vehicle owner must maintain the added cost of a geographical area code telephone number in addition to a toll-free number to realize the benefits of a non-geographic telephone number. As used throughout this application, the term “toll-free” means that any fees or charges associated with a particular call are borne or paid by the recipient of the call, rather than the person making the call.

Although many advancements have been made since the implementation of toll-free telephone numbers, the limitation of requiring a second geographic area code number to route to an individual telephone has remained. Requiring a second geographic area code number increases the need to introduce new geographic area codes by artificially inflating the number of unique phone numbers. Additionally, requiring a second geographic area code number increases costs to consumers or businesses that must pay for two numbers. Furthermore, this system increases costs by requiring that a device is reprogrammed when sold or moved. The long standing problems of all the above limitations would be eliminated.

The present invention overcomes these disadvantages and advances the state of the art.

### SUMMARY OF THE INVENTION

One aspect of the current invention provides a method of routing a wireless telephone call. The method includes receiving a non-translated telephone call (NTC) at a wireless carrier, determining a serial number associated with the NTC based solely on a phone number associated with the NTC and routing the NTC from the wireless carrier to a mobile device based on the determination.

Another aspect of the current invention provides a computer usable medium comprising computer readable program code for routing a wireless telephone call. The medium includes computer readable program code for receiving a non-translated telephone call (NTC) at a wireless carrier, computer readable program code for determining a serial number associated with the NTC based solely on a phone number associated with the NTC and computer readable program code for routing the NTC from the wireless carrier to a mobile device based on the determination.

Another aspect of the current invention provides a method of providing a communication number to a mobile device. The method includes receiving at least one non-geographic mobile dialed number (NMDN), receiving at least one equipment serial number unique to a mobile device, linking the NMDN to the equipment serial number in a database, storing the NMDN and equipment serial number to a mobile device and assigning the mobile device with linked NMDN and equipment serial number to a subscriber.

Another aspect of the current invention provides a computer usable medium comprising computer readable program code for providing a communication number to a mobile device. The medium includes computer readable program code for providing at least one non-geographic mobile dialed number (NMDN), computer readable program code for providing at least one equipment serial number, computer readable program code for linking the NMDN to the equipment serial number in a database, computer readable program code for storing the NMDN and equipment serial number to a mobile device and computer readable program code for assigning the mobile device with linked NMDN and equipment serial number to a subscriber.

Another aspect of the current invention provides a system of routing a wireless telephone call. The system includes means for receiving a non-translated telephone call (NTC) at a wireless carrier, means for determining a serial number associated with the NTC based solely on a phone number associated with the NTC and means for routing the NTC from the wireless carrier to a mobile device based on the determination.

The aforementioned, and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

The foregoing and other objects, advantages, and features of the present invention will be apparent from the following detailed description and the accompanying drawings, in which:

FIG. 1A illustrates a flowchart of a prior art method for provisioning and activating a wireless device;

FIG. 1B illustrates a system for a call center communicating with a telematics unit in a mobile vehicle;

FIG. 2 illustrates a model of a mobile application service network using a wireless telecommunications network;

FIG. 3 illustrates a model of a system to route non-geographic calls to a wireless device in accordance with one embodiment of the present invention;

FIG. 4 illustrates a flowchart of a method for routing telephone calls to a wireless device in accordance with another embodiment of the present invention;

FIG. 5 illustrates a representative block diagram of a method for provisioning and activating toll-free numbers on a wireless device in accordance with one embodiment of the present invention; and

FIG. 6 illustrates a flowchart of a method for provisioning and activating toll-free numbers on a wireless device in accordance with one embodiment of the present invention.

### DETAILED DESCRIPTION OF THE PRESENTLY PREFERRED EMBODIMENTS

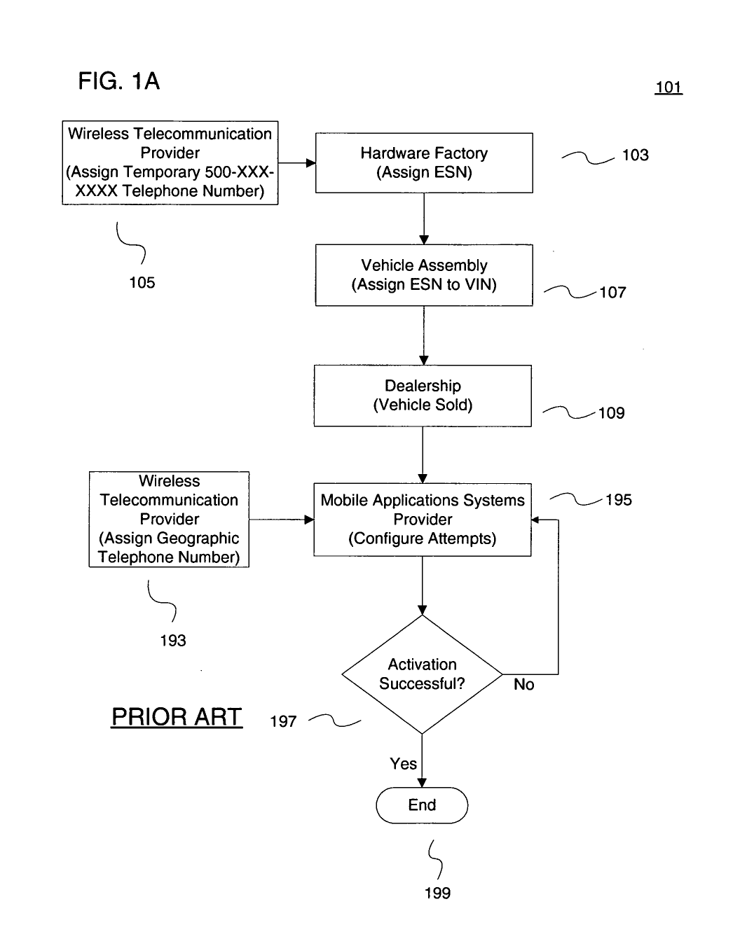

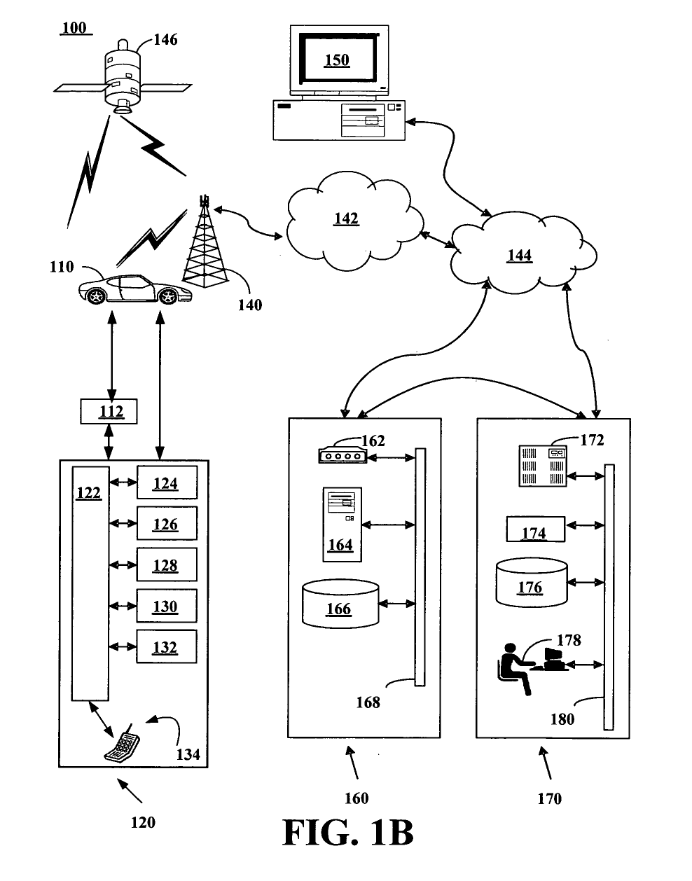

FIG. 1B illustrates a system for a call center communicating with a telematics unit in a mobile vehicle, in accordance with one embodiment of the present invention and shown generally by numeral 100. Mobile vehicle communication system (MVCS) 100 includes a mobile vehicle communication unit (MVCU) 110, a vehicle communication network 112, a telematics unit 120, one or more wireless carrier systems 140, one or more communication networks 142, one or more land networks 144, one or more satellite broadcast systems 146, one or more client, personal or user computers 150, one or more web-hosting portals 160, and one or more call centers 170. In one embodiment, MVCU 110 is implemented as a mobile vehicle equipped with suitable hardware and software for transmitting and receiving voice and data communications. MVCS 100 may include additional components not relevant to the present discussion. Mobile vehicle communication systems and telematics units are known in the art.

MVCU 110 is also referred to as a mobile vehicle in the discussion below. In operation, MVCU 110 is implemented as a motor vehicle, a marine vehicle, or as an aircraft, in various embodiments. MVCU 110 may include additional components not relevant to the present discussion.

Vehicle communication network 112 sends signals to various units of equipment and systems within vehicle 110 to perform various functions such as monitoring the operational state of vehicle systems, collecting and storing data from the vehicle systems, providing instructions, data and programs to various vehicle systems, and calling from telematics unit 120. In facilitating interactions among the various communication and electronic modules, vehicle communication network 112 utilizes interfaces such as controller-area network (CAN), Media Oriented System Transport (MOST), Local Interconnect Network (LIN), Ethernet (10 base T, 100 base T), International Organization for Standardization (ISO) Standard 9141, ISO Standard 11898 for high-speed applications, ISO Standard 11519 for lower speed applications, and Society of Automotive Engineers (SAE) standard J1850 for higher and lower speed applications. In one embodiment, vehicle communication network 112 is a direct connection between connected devices.

Telematics unit 120 sends to and receives radio transmissions from wireless carrier system 140. Wireless carrier system 140 is implemented as any suitable system for transmitting a signal from MVCU 110 to communication network 142.

Telematics unit 120 includes a processor 122 connected to a wireless modem 124, a global positioning system (GPS) unit 126, an in-vehicle memory 128, a microphone 130, one or more speakers 132, and an embedded or in-vehicle mobile phone 134. In other embodiments, telematics unit 120 is implemented without one or more of the above listed components such as, for example, speakers 132. Telematics unit 120 may include additional components not relevant to the present discussion.

In one embodiment, processor 122 is implemented as a microcontroller, controller, host processor, or vehicle communications processor. In an example, processor 122 is implemented as an application specific integrated circuit (ASIC). In another embodiment, processor 122 is implemented as a processor working in conjunction with a central processing unit (CPU) performing the function of a general purpose processor. GPS unit 126 provides latitudinal and longitudinal coordinates of the vehicle responsive to a GPS broadcast signal received from one or more GPS satellite broadcast systems (not shown). In-vehicle mobile phone 134 is a cellular-type phone such as, for example a digital, dual-mode (e.g., analog and digital), dual-band, multi-mode or multi-band cellular phone. In one embodiment, processor 122 determines route corrections based on transmitted digital map information from the call center 170.

Processor 122 executes various computer programs that control programming and operational modes of electronic and mechanical systems within MVCU 110. Processor 122 controls communications (e.g., call signals) between telematics unit 120, wireless carrier system 140, and call center 170. Additionally, processor 122 controls reception of communications from satellite broadcast system 146. In one embodiment, a voice-recognition application is installed in processor 122 that can translate human voice input through microphone 130 to digital signals. Processor 122 generates and accepts digital signals transmitted between telematics unit 120 and a vehicle communication network 112 that is connected to various electronic modules in the vehicle. In one embodiment, these digital signals activate the programming mode and operation modes, as well as provide for data transfers such as, for example, data over voice channel communication. In this embodiment, signals from processor 122 are translated into voice messages and sent out through speaker 132.

Wireless carrier system 140 is a wireless communications carrier or a mobile telephone system and transmits to and receives signals from one or more MVCU 110. Wireless carrier system 140 incorporates any type of telecommunications in which electromagnetic waves carry signal over part of or the entire communication path. In one embodiment, wireless carrier system 140 is implemented as any type of broadcast communication in addition to satellite broadcast system 146. In another embodiment, wireless carrier system 140 provides broadcast communication to satellite broadcast system 146 for download to MVCU 110. In an example, wireless carrier system 140 connects communication network 142 to land network 144 directly. In another example, wireless carrier system 140 connects communication network 142 to land network 144 indirectly via satellite broadcast system 146.

Satellite broadcast system 146 transmits radio signals to telematics unit 120 within MVCU 110. In one embodiment, satellite broadcast system 146 may broadcast over a spectrum in the “S” band (2.3 GHz) that has been allocated by the U.S. Federal Communications Commission (FCC) for nationwide broadcasting of satellite-based Digital Audio Radio Service (DARS).

In operation, broadcast services provided by satellite broadcast system 146 are received by telematics unit 120 located within MVCU 110. In one embodiment, broadcast services include various formatted programs based on a package subscription obtained by the user and managed by telematics unit 120. In another embodiment, broadcast services include various formatted data packets based on a package subscription obtained by the user and managed by call center 170. Data packets include route data and digital map information. In an example, digital map information data packets received by the telematics unit 120 from the call center 170 are implemented by processor 122 to determine a route correction.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, and call center 170. In one embodiment, land network 144 is a public-switched telephone network (PSTN). In another embodiment, land network 144 is implemented as an Internet protocol (IP) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160 and call center 170.

Client, personal, or user computer 150 includes a computer usable medium to execute Internet browser and Internet-access computer programs for sending and receiving data over land network 144 and, optionally, wired or wireless communication networks 142 to web-hosting portal 160. Computer 150 sends user preferences to web-hosting portal 160 through a web-page interface using communication standards such as hypertext transport protocol (HTTP), and transport-control protocol and Internet protocol (TCP/IP). In one embodiment, the data includes directives to change certain programming and operational modes of electronic and mechanical systems within MVCU 110. In another or the same embodiment, rules for determining probable off-route conditions are configurable through the web-hosting portal 160.

In operation, a client utilizes computer 150 to initiate setting or re-setting of user preferences for MVCU 110 and/or probable off-route condition determinations. In an example, a client utilizes computer 150 to provide radio station presets as user preferences for MVCU 110. User-preference data from client-side software is transmitted to server-side software of web-hosting portal 160. In an example, user-preference data is stored at web-hosting portal 160. In another example, a client utilizes computer 150 to configure rules used by call center 170 for determining probable off-route condition(s).

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 transmits digital data to and from modem 162, data that is then transferred to web server 164. In one embodiment, modem 162 resides inside web server 164. Land network 144 transmits data communications between web-hosting portal 160 and call center 170.

Web server 164 receives user-preference data from computer 150 via land network 144. In alternative-embodiments, computer 150 includes a wireless modem to send data to web-hosting portal 160 through a wireless communication network 142 and a land network 144. Data is received by land network 144 and sent to one or more web servers 164. In one embodiment, web server 164 is implemented as any suitable hardware and software capable of providing web services to help change and transmit personal preference settings from a client at computer 150 to telematics unit 120 in MVCU 110. Web server 164 sends to or receives from one or more databases 166 data transmissions via network system 168. Web server 164 includes computer applications and files for managing and storing personalization settings supplied by the client, such as door lock/unlock behavior, radio station preset selections, climate controls, custom button configurations, and theft alarm settings. For each client, the web server potentially stores hundreds of preferences for wireless vehicle communication, networking, maintenance, and diagnostic services for a mobile vehicle. In another embodiment, web server 164 further includes data for managing turn-by-turn navigational instructions.

In one embodiment, one or more web servers 164 are networked via network system 168 to distribute user-preference data among its network components such as database 166. In an example, database 166 is a part of or a separate computer from web server 164. Web server 164-sends data transmissions with user preferences to call center 170 through land network 144.

Call center 170 is a location where many calls are received and serviced at the same time, or where many calls are sent at the same time. In one embodiment, the call center is a telematics call center, facilitating communications to and from telematics unit 120 in MVCU 110. In another embodiment, the call center is a voice call center, providing verbal communications between an advisor in the call center and a subscriber in a mobile vehicle. In yet another embodiment, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmissions via network system 180. In one embodiment, communication services manager 174 includes at least one digital and/or analog modem.

Communication services manager 174 sends to or receives from one or more communication services advisors 178 data transmissions via network system 180. Communication services database 176 sends to or receives from communication services advisor 178 data transmissions via network system 180. Communication services advisor 178 receives from or sends to switch 172 voice or data transmissions. Communication services manager 174 provides one or more of a variety of services including initiating data over voice channel wireless communication, enrollment services, navigation assistance, directory assistance, roadside assistance, business or residential assistance, information services assistance, emergency assistance, and communications assistance.

Communication services manager 174 receives service-preference requests for a variety of services from the client via computer 150, web-hosting portal 160, and land network 144. Communication services manager 174 transmits user-preference and other data such as, for example, primary diagnostic script to telematics unit 120 in MVCU 110 through wireless carrier system 140, communication network 142, land network 144, voice and data switch 172, and network system 180. Communication services manager 174 stores or retrieves data and information from communication services database 176. Communication services manager 174 may provide requested information to communication services advisor 178. In one embodiment, communication services advisor 178 is implemented as a real advisor. In an example, a real advisor is a human being in verbal communication with a user or subscriber (e.g., a client) in MVCU 110 via telematics unit 120. In another embodiment, communication services advisor 178 is implemented as a virtual advisor. In an example, a virtual advisor is implemented as a synthesized voice interface responding to service requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, automated vehicle diagnostic function, and communications assistance. Communication services advisor 178 communicate with telematics unit 120 in MVCU 110 through wireless carrier system 140, communication network 142, and land network 144 using voice transmissions, or through communication services manager 174 and switch 172 using data transmissions. Switch 172 selects between voice transmissions and data transmissions.

In operation, an incoming call is routed to telematics unit 120 within mobile vehicle 110 from call center 170. In one embodiment, the call is routed to telematics unit 120 from call center 170 via land network 144, communication network 142, and wireless carrier system 140. In another embodiment, an outbound communication is routed to telematics unit 120 from call center 170 via land network 144, communication network 142, wireless carrier system 140, and satellite broadcast system 146. In this embodiment, an inbound communication is routed to call center 170 from telematics unit 120 via wireless carrier system 140, communication network 142, and land network 144.

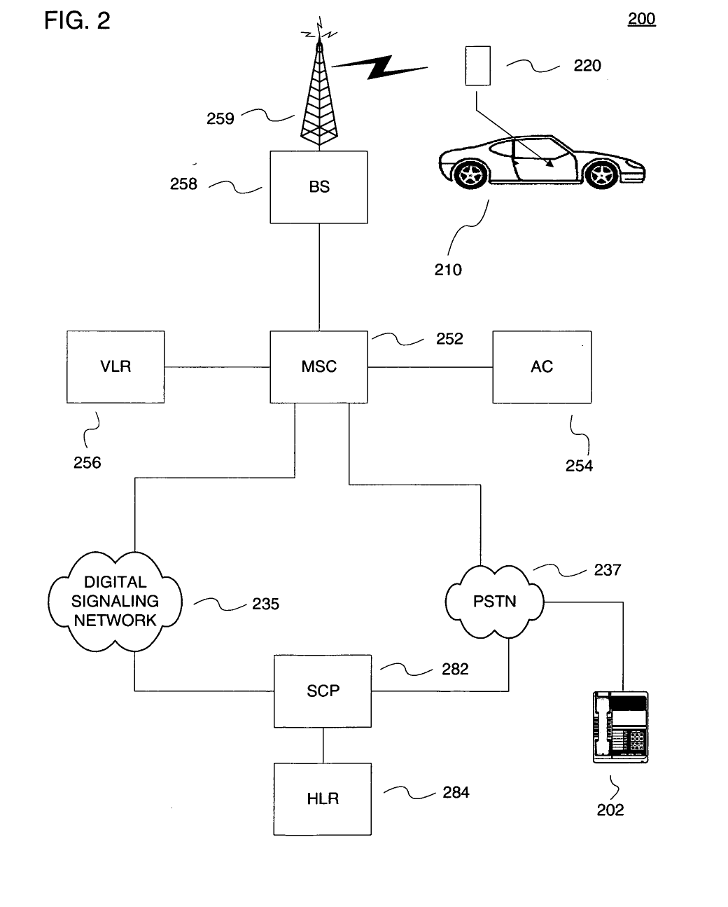

FIG. 2 illustrates a representative model of a mobile application service network using a wireless telecommunications network. Vehicle 210 is mobile: either self propelled or propelled by another source of power. Vehicle 210 includes a telematics unit 220 capable of two-way radio communication with a fixed base station (BS) 258 having an antenna 259. Telematics unit 220 communicates with BS 258 within a limited coverage area around BS 258, as well as with other base stations as it moves through their limited coverage areas. BS 258 is connected by communication lines to a mobile switching center (MSC) 252. The communication lines connecting BS 258 and MSC 252 may be wired connections, or wireless connections. Wireless connections can be a short range connection, such as a cellular or radio connection or a long-range connection, such as with a satellite (not shown).

BS 258 and MSC 252 are operated by a wireless telecommunication service provider in a defined geographic service area. MSC 252 is part of a wireless telecommunications network providing mobile stations, such as telematics unit 220, communication capability with other stations, either mobile or stationary.

In addition to BS 258 and MSC 252, the wireless telecommunications network includes a digital signaling network 235 capable of carrying data messages and a public switched telephone network (PSTN) 237 capable of carrying voice and data transmissions. In one embodiment, the data messages are configured as IS-41 messages, according to the ANSI/TIA/EIA-41.5 Cellular Radiotelecommunications Intersystem Operations specification. In one embodiment, network 235 is an Integrated Services Digital Network (“ISDN”). In another embodiment, network 235 is a Common Channel Signaling System Number 7 (“SS7”) network. In another embodiment, network 235 is a network configured under a protocol administered by the International Telecommunication Union-Telecommunication Standardization Sector, such as X-25. Digital signaling network 235 and PSTN 237 extend over a geographical area—potentially all of a political subdivision or a continent—over which mobile application services are provided to moving vehicles. In addition, land line telephones 202 connect to the system via the PSTN 237. MSC 252 is further connected to a visitor location register (VLR) 256 containing temporary location, status and service information concerning telematics unit 220 and other mobile stations registered as visitors with MSC 252. MSC 252 may optionally be connect to an authentication center (AC) 254 for performing authentication functions relative to mobile stations, including telematics unit 220, attempting access. In one embodiment, AC 254 is implemented as call center 170.

The wireless telecommunication service provider also provides and maintains at least one home registry database 284. In one embodiment, the home registry database 284 is a home location register (HLR) connected via a service control point (SCP) 282 to digital signaling network 235 and PSTN 237. The home registry database 284 contains subscriber profile data for all mobile stations, including telematics unit 220. In one embodiment, the profile data includes the telematics unit location, subscriber status, call restrictions, and equipment serial numbers (ESN).

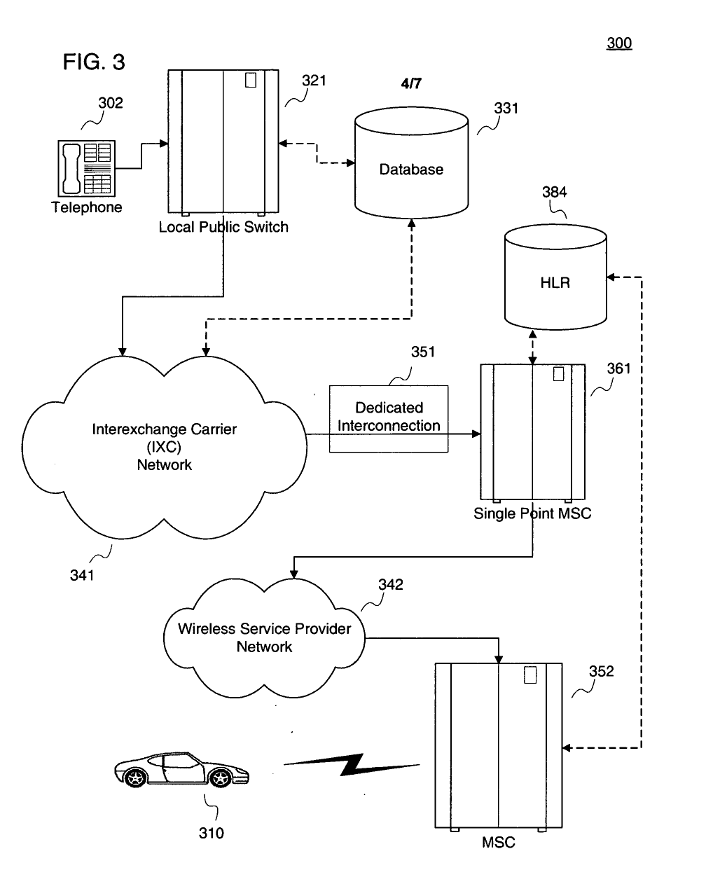

FIG. 3 illustrates a representative model 300 of data signal flow and call flow for a toll-free telephone call to a wireless device. A call is initiated at telephone 302. Telephone 302 is represented in this model as a landline telephone. However, the initiating telephone and associated network may be either a landline telephone or a wireless device. The dialed number is received at the public switch 321 where a service switching point (SSP) queries a database downloaded from the database 331 for routing information. In one embodiment, database 331 is a SMS/800 database. The database 331 is a telecommunications database containing routing and customer information received from toll-free service providers, such the interexchange carrier (IXC) 341. The public switch 321 routes the call to the IXC based on the information contained in the database 331. The IXC 341 receives the call and must determine whether to translate the call into a standard geographical ten-digit telephone number to be handed off to a local carrier, or route the call to a second network non-translated. In the present invention, the IXC 341 routes the non-translated telephone call (NTC) to the wireless service provider's network 342 at a dedicated interconnection point 351. The wireless service provider routes the NTC onto their wireless network 342 from the dedicated interconnection point 351 to a single point mobile switching center (MSC) 361. The wireless service provider then queries a Home Location Register (HLR) 384 for an equipment serial number and a non-geographic mobile dialed number (NMDN) matching the received NTC. HLR 384 also contains the location and routing information of equipment serial number and NMDN and the wireless service provider routes the call via wireless network 342 to a local MSC 352 where the call is then routed to the mobile device, such as telematics unit 120 within vehicle 310.

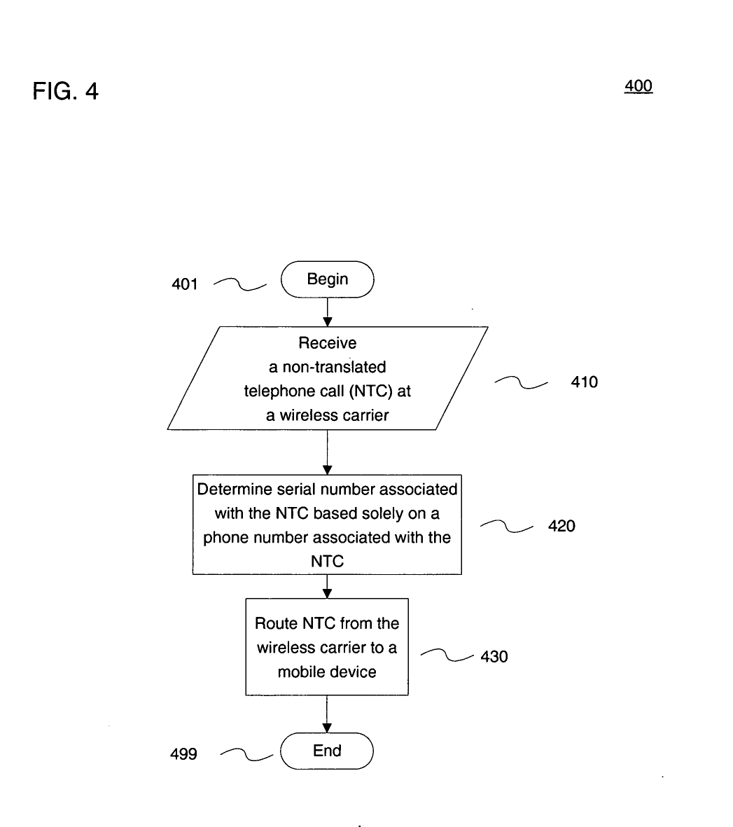

FIG. 4 illustrates a flowchart of a method 400 for routing telephone calls to a wireless device in accordance with one embodiment of the present invention. Method 400 begins at step 401.

A non-translated telephone call (NTC) is received at a wireless carrier in step 410. An NTC is any call to a non-geographic telephone number that is routed solely based on the phone number dialed. In one embodiment, when a telephone call to a wireless non-geographic telephone number is initiated, the call is identified as a non-geographic number and passed to an interexchange telecommunications carrier (IXC) for processing. The IXC may “translate” the non-geographic number into a geographic area code number to facilitate routing. An NTC is not translated by the IXC but, rather, is handed off to another service provider or end user as the original NTC phone number. In the present embodiment, the IXC interfaces with a wireless service provider at a dedicated interconnection point where the NTC is received on the wireless service provider's network.

A serial number associated with the NTC based solely on a phone number associated with the NTC is determined in step 420. The serial number is an identifying code unique to a mobile device. In one embodiment, the serial number is a sequential alphanumeric code programmed into the mobile device during manufacturing. In other embodiments, the serial number could be programmed and re-programmed into the device any time after manufacturing. In the preferred embodiment, the phone number associated with the NTC is a non-geographic mobile dialed number (NMDN). A NMDN is a telephone number programmed into a mobile device that has no geographic identifier such as a geographically based area code or central office identifying prefix. For example, in an embodiment where the NDMN is a toll-free telephone number, the NDMN could include any of the area codes: 800, 888, 877, 866, 855, 844, 833 and 822. Other embodiments of a NDMN include 900 and 976 fee-based area codes, and “follow me” 500 area codes. In another embodiment, a newly established NMDN area code would be used. For example, a new three digit NMDN would be assigned to mobile devices and create a new class of service. In another embodiment, a block of NMDN numbers would be dedicated to a particular mobile applications service provider. For example, all 822-5XX-XXXX numbers would be assigned and easily identified with a single mobile applications service provider.

In one embodiment, a database query is performed to determine the linked serial numbers and NMDNs. For example, a Home Location Register (HLR) database contains the serial numbers and corresponding NMDNs of the subscribers to a particular wireless service. If more than one HLR database is provided, each HLR database contains complete and mirrored information concerning the subscriber's serial numbers and the telephone number linked to the subscriber's unique serial number. The HLR database is queried to find the serial number linked to the NTC.

The NTC is routed from the wireless carrier to the mobile device in step 430. In one embodiment, the mobile device is a telematics unit. In another embodiment the HLR database is accessed to determine the appropriate mobile service center (MSC) to route the NTC. The HLR database 525 maintains an up to date record of the location and routing information for each subscriber. The database is queried to determine the appropriate mobile switching center 230 and base station 220 to route the NTC. Method 400 terminates at step 499.

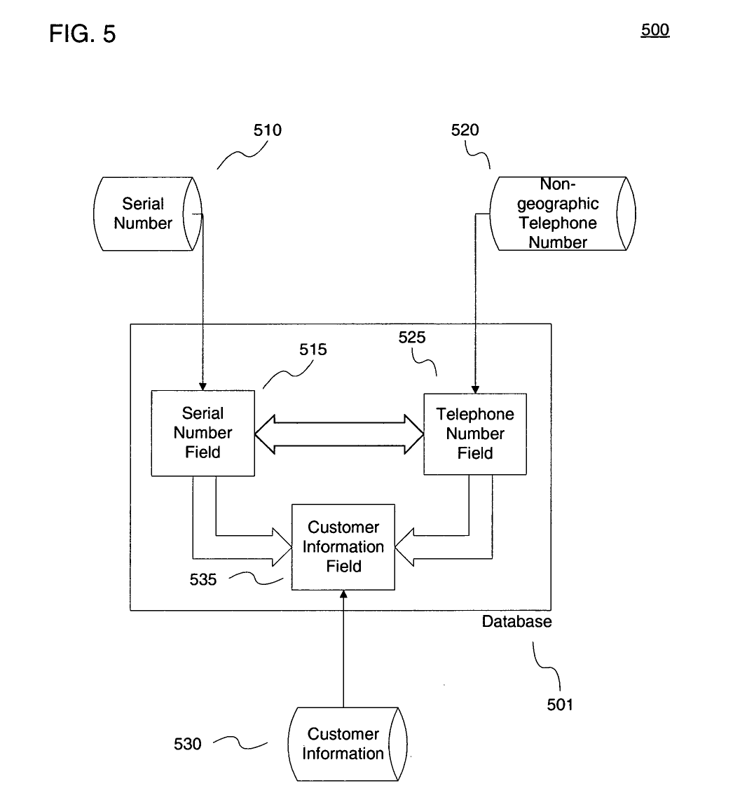

FIG. 5 illustrates a block diagram 500 for provisioning and activating toll-free numbers on a wireless device, in accordance with one embodiment of the present invention. Database 501 is shown as a partial record. Database 501 may contain other fields not pertinent to the present invention.

A unique serial number 510 is provided and stored in database 501 in a serial number field 515. The serial number field 515 is linked to the telephone number field 525 via database logic. A NMDN is received and entered into the database 501 to be linked to the serial number 510 through database fields 515 and 525. When the mobile device is assigned to a subscriber, customer information 530 is entered into database 501 via at least one customer information field 535. In one embodiment, the customer information is entered into multiple fields including, for example: name, address, account number, and billing information. Method 500 terminates at step 599.

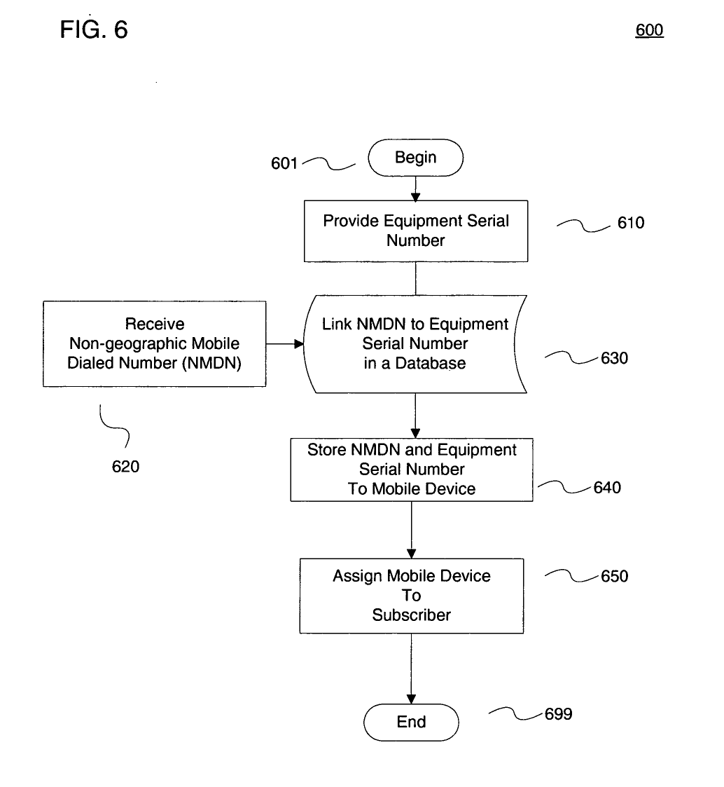

FIG. 6 illustrates a flowchart of a method 600 for providing a communication number to a mobile device in accordance with one embodiment of the present invention. Method 600 begins at step 601.

At least one equipment serial number unique to a mobile device is provided in step 610. In one embodiment, the equipment serial number is implemented as unique serial number 510. In one embodiment, the equipment serial number is received at a database, such as database 501, for further association with other data.

At least one NMDN is received in step 620. In one embodiment, the NMDN is received at a database, such as database 501.

The NMDN is linked to the equipment serial number in a database in step 630. In one embodiment, the database is implemented as database 501.

The NMDN and equipment serial number are stored to a mobile device in step 640. In one embodiment, the mobile device is implemented as telematics units 120, 220, 320.

The mobile device with linked NMDN and equipment serial number is assigned to a subscriber in step 650. Assigning a mobile device to a subscriber includes a sale or lease to a consumer, in one embodiment. Method 600 terminates at step 699.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of routing a wireless telephone call, the method comprising:
receiving a non-translated telephone call (NTC) at a wireless carrier;
determining a serial number associated with the NTC based solely on a phone number associated with the NTC; and
routing the NTC from the wireless carrier to a mobile device based on the determination.

2. The method of claim 1, wherein the mobile device is a telematics unit comprised of a processor connected to a wireless modem, a global positioning system (GPS) unit, an in-vehicle memory, a microphone, one or more speakers, and an embedded or in-vehicle mobile phone.

3. The method of claim 1, wherein the phone number is a non-geographic mobile dialed number (NMDN).

4. The method of claim 3, wherein the NMDN is a toll-free number.

5. The method of claim 1, wherein the NTC is received from an interexchange telecommunications carrier (IXC) at a dedicated interconnection point.

6. The method of claim 1, further comprising providing a Home Location Registry (HLR) database, HLR database comprising the serial number linked to the phone number associated with the NTC and location and routing information associated with the serial number.

7. A computer usable medium comprising computer readable program code for routing a wireless telephone call, the medium comprising:
computer readable program code for receiving a non-translated telephone call (NTC) at a wireless carrier;
computer readable program code for determining a serial number associated with the NTC based solely on a phone number associated with the NTC; and
computer readable program code for routing the NTC from the wireless carrier to a mobile device based on the determination.

8. The medium of claim 7, wherein the NMDN is a toll-free number.

9. The medium of claim 7, wherein the NTC is received from an interexchange telecommunications carrier (IXC) at a dedicated interconnection point.

10. The medium of claim 7, further comprising computer readable program code for querying a Home Location Registry (HLR) database.

11. A method of providing a communication number to a mobile device, the method comprising:
receiving at least one non-geographic mobile dialed number (“NMDN”);
providing at least one equipment serial number unique to a mobile device;
linking the NMDN to the equipment serial number in a database;
storing the NMDN and equipment serial number to a mobile device; and
assigning the mobile device with linked NMDN and equipment serial number to a subscriber.

12. The method of claim 11, wherein the NMDN comprises an area code unique to a mobile applications system provider.

13. The method of claim 11, wherein the NMDN is a toll-free number.

14. The method of claim 11, wherein storing the NMDN and equipment serial number to a mobile device is based on linking the NMDN to the equipment serial number in a database.

15. The method of claim 11, wherein assigning the mobile device to a subscriber comprises linking a customer identifier to the database record corresponding to the linked NMDN and equipment serial number.

16. A computer usable medium comprising computer readable program code for providing a communication number to a mobile device, the medium comprising:
computer readable program code for providing at least one non-geographic mobile dialed number (NMDN);
computer readable program code for providing at least one equipment serial number;
computer readable program code for linking the NMDN to the equipment serial number in a database;
computer readable program code for storing the NMDN and equipment serial number to a mobile device; and
computer readable program code for assigning the mobile device with linked NMDN and equipment serial number to a subscriber.

17. The medium of claim 16, wherein the NMDN comprises an area code unique to a mobile applications system provider.

18. The medium of claim 16, wherein storing the NMDN and equipment serial number to the mobile device is based on linking the NMDN to the equipment serial number in a database.

19. The medium of claim 16, wherein assigning the mobile device to a subscriber comprises linking a customer identifier to the database record corresponding to the linked NMDN and equipment serial number.

20. A system for routing a wireless telephone call, the system comprising:
means for receiving a non-translated telephone call (NTC) at a wireless carrier;
means for determining a serial number associated with the NTC based solely on a phone number associated with the NTC; and
means for routing the NTC from the wireless carrier to a mobile device based on the determination.
